(19) United States
(12) Patent Application Publication
(10) Pub. No.: US 2011/0213936 A1
(43) Pub. Date: Sep. 1, 2011

(54) PROCESSOR, MULTIPROCESSOR SYSTEM, AND METHOD OF DETECTING ILLEGAL MEMORY ACCESS

(75) Inventor: Takashi MIURA, Kanagawa (JP)

(73) Assignee: KABUSHIKI KAISHA TOSHIBA, Tokyo (JP)

(21) Appl. No.: 12/759,039

(22) Filed: Apr. 13, 2010

(30) Foreign Application Priority Data
Mar. 1, 2010 (JP) 2010-044593

(51) Int. Cl. G06F 12/00

(52) U.S. Cl. 711/147; 711/E12.001

(57) ABSTRACT

A processor included in a multiprocessor system including a shared memory, the processor according to an embodiment of the present invention comprises: a storing unit that stores a break occurrence memory area that is address information of the shared memory; and a break generator that causes memory access break when the break occurrence memory area is accessed and puts the processor to a debug state. The break occurrence memory area includes address information of the shared memory in another processor included in the multiprocessor system.

### CROSS-REFERENCE TO RELATED APPLICATIONS

This application is based upon and claims the benefit of priority from the prior Japanese Patent Application No. 2010-044593, filed on Mar. 1, 2010; the entire contents of which are incorporated herein by reference.

### BACKGROUND OF THE INVENTION

1. Field of the Invention

The present invention relates to a processor included in a shared memory multiprocessor system, a multiprocessor system, and a method of detecting illegal memory access to a shared memory.

2. Description of the Related Art

In recent years, an LSI including a symmetric multiprocessor (MSP) on one chip is generally used. This is because, whereas a rate of improvement of single MP performance is dulled because of limitation on power consumption and the like, it is more advantageous in overall processing performance per power consumption to integrate a plurality of microprocessors (MP) of the same specifications and execute software in parallel.

In the case of a SMP for built-in use, a main memory is often shared from the viewpoint of cost. Specifically, some microprocessor for built-in use has a primary cache but does not have a coherency function between the primary cache and a lower shared memory.

A problem that occurs when the lower shared memory is shared by a plurality of processors without cache coherency function is that the shared memory has to be correctively exclusively managed when a plurality of kinds of software are executed in parallel. Further, for built-in use, because software itself includes multiple tasks, exclusive control has to be realized among tasks in one kind of software as well. Therefore, an illegal-access detecting technology between a plurality of tasks for detecting that a memory is not correctly accessed is important in improvement of debug efficiency in software development.

Software executed in a system includes a plurality of tasks and one kernel. The software is simultaneously executed by a plurality of microprocessors in parallel. Commands of a computer program and data have to be stored in a shared memory and executed without illegal memory access, i.e., memory breakage while being subjected to limitation of cache coherency.

In general, when a plurality of tasks are executed on a shared memory, a memory area peculiar to certain one task has to be protected from breakage due to operation of the other tasks. Moreover, memory content shared with the other tasks has to be inhibited from being updated from the other tasks within time in which it is expected that the task occupies the shared memory on a computer program. In other words, the occupation of the shared memory must be guaranteed during the time which certain one task assigns.

In the case of a single processor, there is only one task that can be executed at the same time. Therefore, if switching of the task is prevented within the time, the occupation of the shared memory is automatically guaranteed. Therefore, debug of the computer program is possible if access to the outside of a memory area permitted to the own task (illegal memory access) is monitored and detected. Illegal memory access is due to a program mistake of a user.

Concerning use of a memory among tasks in the case of the single processor, technologies that can be used even when there is no hardware-like memory protecting mechanism have already been proposed (see, for example, Japanese Patent Application Laid-Open No. 2007-334541 and Japanese Patent Application Laid-Open No. 2008-40964).

However, both the technologies are devised from the viewpoint of the single processor. In the case of multiprocessors that simultaneously operate in parallel, detection of illegal access cannot be performed concerning a memory area shared for data exchange among a plurality of tasks.

### BRIEF SUMMARY OF THE INVENTION

A processor included in a multiprocessor system including a shared memory, the processor according to an embodiment of the present invention comprises: a storing unit that stores a break occurrence memory area that is address information of the shared memory; and a break generator that causes memory access break when the break occurrence memory area is accessed and puts the processor to a debug state, wherein the break occurrence memory area includes address information of the shared memory in another processor included in the multiprocessor system.

A multiprocessor system according to an embodiment of the present invention comprises: a shared memory; a first processor that accesses the shared memory; and a second processor that accesses the shared memory, wherein the first processor includes: a first storing unit that stores a first break occurrence memory area that is address information of the shared memory; and a first break generator that causes memory access break when the first break occurrence memory area is accessed and puts the first processor to a debug state, the second processor includes: a second storing unit that stores a second break occurrence memory area that is address information of the shared memory; and a second break generator that causes memory access break when the second break occurrence memory area is accessed and puts the second processor to a debug state, and the first break occurrence memory area includes address information of the shared memory in the second processor and the second break occurrence memory area includes address information of the shared memory in the first processor.

A method of detecting illegal access to a shared memory in a multiprocessor system including the shared memory, a first processor, and a second processor, the method according to an embodiment of the present invention comprises: designating, as a first break occurrence area, address information of the shared memory accessed by the second processor; monitoring access to the shared memory by the first processor; and putting the first processor to a debug state and causing memory access break when it is monitored that the first processor accesses the designated first break occurrence memory area.

### BRIEF DESCRIPTION OF THE DRAWINGS

FIG. 1 is a diagram of the configuration of a multiprocessor included in a multiprocessor system of a shared memory type according to an embodiment of the present invention;

FIG. 2 is a diagram of the configuration of the multiprocessor system of the shared memory type according to the embodiment;

FIG. 3 is a diagram of the configuration of software according to the embodiment;

FIG. 4 is a diagram a TASK execution information table according to the embodiment;

FIG. 5 is a diagram of a TASK-start-standby queue table according to the embodiment;

FIG. 6 is a flowchart for explaining the operation of a user program according to the embodiment;

FIG. 7 is a flowchart for explaining kernel operation during generation and during start of a task;

FIG. 8 is a flowchart for explaining kernel operation during task start;

FIG. 9 is a flowchart for explaining the operation of a task in a user program according to the embodiment;

FIG. 10 is a diagram of a memory access area that one task intends to access;

FIG. 11 is a diagram of a state of use of a shared memory including a memory access area that both two tasks intend to access; and

FIG. 12 is a flowchart for explaining kernel operation during memory use permission notification according to the embodiment.

### DETAILED DESCRIPTION OF THE INVENTION

Exemplary embodiments of processor, multiprocessor system, and method of detecting illegal access to a shared memory according to the present invention will be explained below in detail with reference to the accompanying drawings.

The present invention is not limited to the following embodiments.

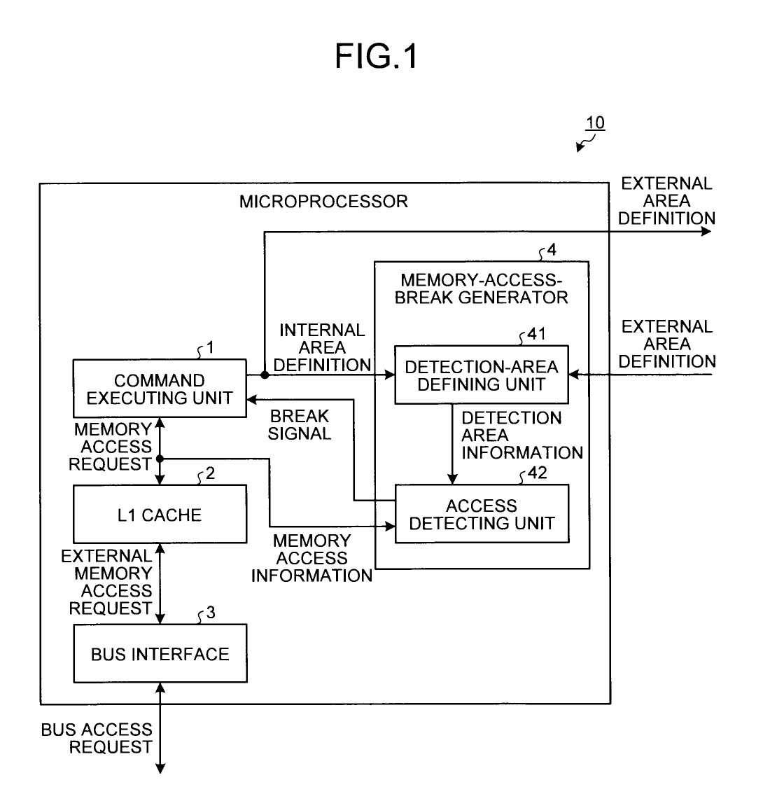

FIG. 1 is a diagram of the configuration of a microprocessor (MP) 10 included in a multiprocessor system of a shared memory type according to an embodiment of the present invention. The microprocessor 10 includes a command executing unit 1, an L1 cache 2, a bus interface 3, and a memory-access-break generator 4. The memory-access-break generator 4 includes a detection-area defining unit 41 and an access detecting unit 42.

The microprocessor 10 does not have a hardware-like memory protecting function for a shared memory shared with other microprocessors. However, as indicated by the configuration shown in FIG. 1, the microprocessor 10 has a debug break function for data access.

The microprocessor 10 applies processing to memory data stored in an external memory according to a computer program of the command executing unit 1. An access request for memory data necessary for computer program execution is transmitted from the command executing unit 1 to the L1 cache 2. When the data for which memory access is requested is not stored, the L1 cache 2 requests the bus interface 3 to access the external memory and stores the memory data in the L1 cache 2.

When the external memory access request is received, the bus interface 3 sends a memory access request to a bus on the outside of the microprocessor 10 as bus access.

The memory-access-break generator 4 has a function of generating a break signal for memory access to a specific memory area of a shared memory among memory access performed by the command executing unit 1 and putting the command executing unit 1 to break (a debug state).

The specific memory area is defined as an internal area for the command executing unit 1 and is defined as an external area for the outside of the microprocessor 10. The internal area and the external area are stored in the detection-area defining unit 41. This area information is supplied to the access detecting unit 42 as detection area information.

The command executing unit 1 is capable of defining an external area for detection-area defining units of the other processors (not shown) that share the shared memory.

The access detecting unit 42 monitors memory access information of a memory access request issued by the command executing unit 1. When the detection area information given from the detection-area defining unit 41 satisfies a condition, the access detecting unit 42 generates a break signal to the command executing unit 1 and puts the command executing unit 1 to break (the debug state).

A shared memory multiprocessor system according to an embodiment of the present invention will be explained below.

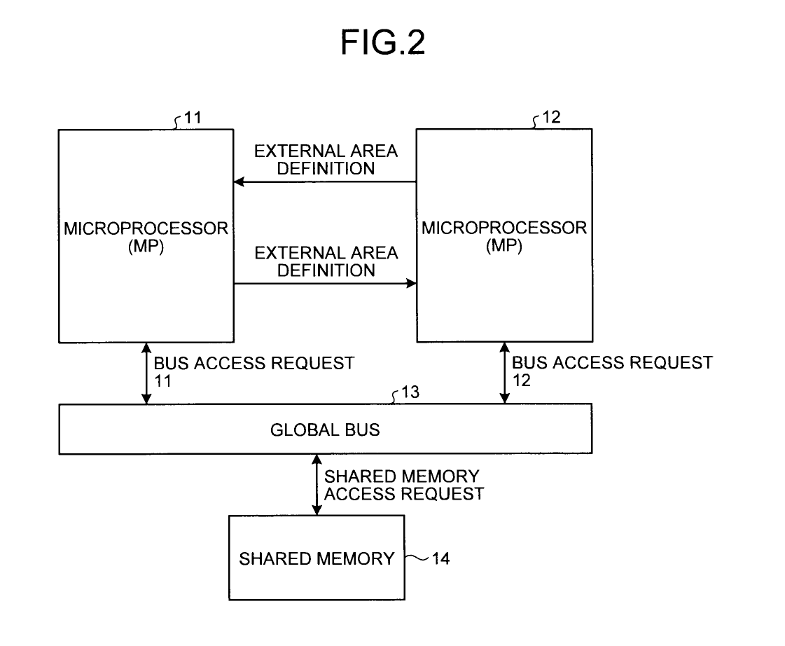

As an example of a symmetric shared memory multiprocessor system (SMP) including a plurality of microprocessors, the configuration of a shared memory multiprocessor system including, for example, a pair of the microprocessors shown in FIG. 1 is shown in FIG. 2.

In this embodiment, each of two microprocessors (MP) 11 and 12 includes the microprocessor shown in FIG. 1. Bus access requests 11 and 12 to the outside of the microprocessors are requests for access to a shared memory 14 via a global bus 13.

To detect illegal memory access between the microprocessors 11 and 12, an internal area definition of the microprocessor 11 is transmitted to the microprocessor 12 and set in the microprocessor 12 as an external area definition. Similarly, an external area definition of the microprocessor 12 is connected to the microprocessor 11 and set by the microprocessor 11. This enables mutual detection between the microprocessors 11 and 12 concerning access to a specific memory area.

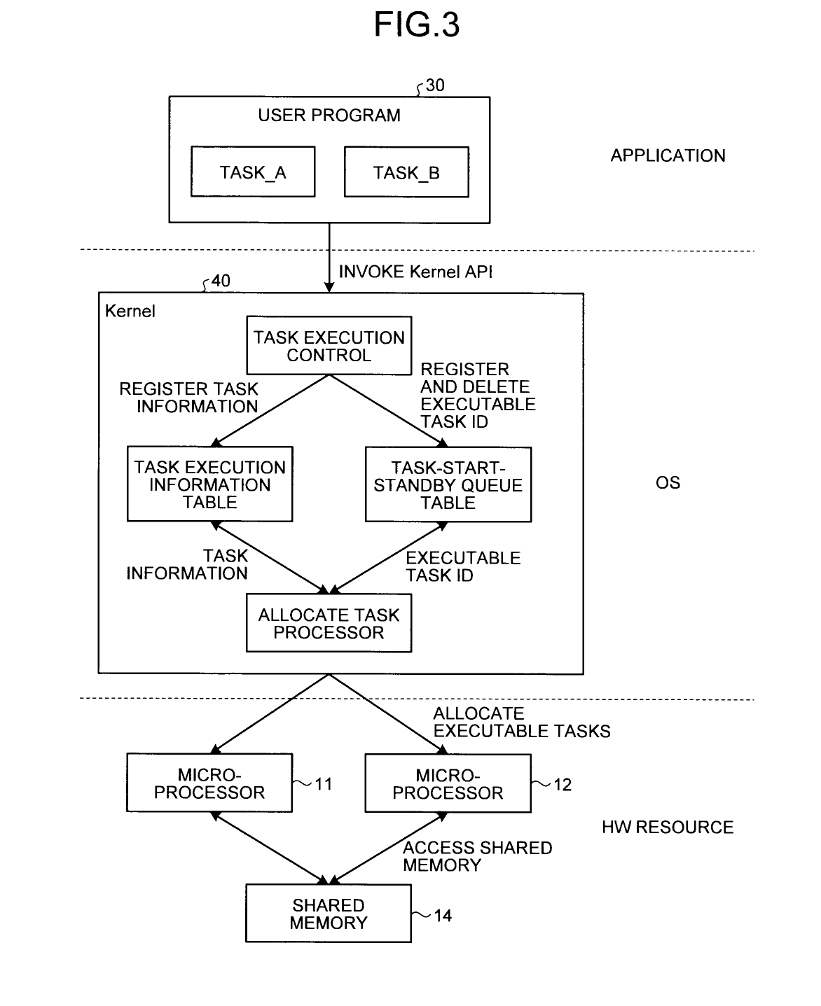

A configuration example of software (SW) executed by the SMP and subjected to the application of a debug function for detecting memory breakage in this embodiment is shown in FIG. 3.

The software as an illegal access detection target in this embodiment includes three sections, i.e., an application, an operating system (OS), and a hardware (HW) resource.

A user program 30 as the application includes a plurality of tasks. In this example, the user program 30 includes a main program and TASK_A and TASK_B.

The user program 30 is executed on a kernel 40 included in the OS as a multitask program intended to perform correct operation in a multiprocessor involving kernel API invocation that takes into account control of the HW resource performed by the OS.

The kernel 40 in the OS converts a request from the application into executable task (program) allocation to the microprocessors 11 and 12 in the HW resource. The microprocessors 11 and 12 perform data access to the shared memory 14 shared among the tasks.

With this mechanism, the user program 30 including the tasks is executed under the OS, task simultaneous executability (the number of processors) of which is concealed.

In the OS, operation explained below is performed according to the API invocation from the user program to a task-execution control unit.

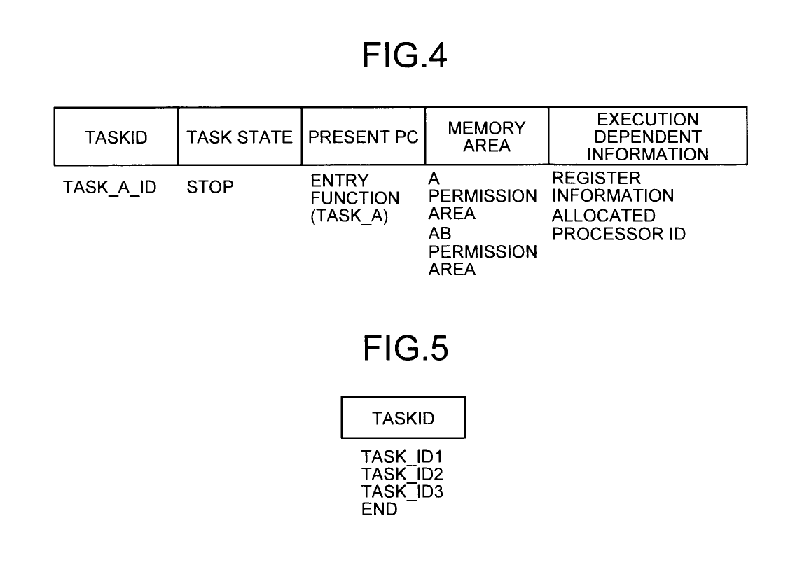

During task generation, the task-execution control unit allocates a task ID and registers the task ID in a TASK execution information table, which is under the management in the kernel, as task information. FIG. 4 is an example of the TASK execution information table. The TASK execution information table has data of TASKID, a TASK state, a present program counter (PC), a memory area, and execution dependent information.

During task start, the task ID is registered in a TASK-start-standby queue table, which is under the management in the kernel, as an executable task ID. FIG. 5 is an example of the TASK-start-standby queue table.

During task deletion, when a relevant task ID is present in the TASK-start-standby queue table, the task ID is deleted from the TASK-start-standby queue table and also deleted from the TASK execution information table.

When a condition for loss of an execution right of a task is satisfied, for example, when API invocation for waiting for completion of execution of another specific task while the task is executed and the specific task does not end the execution, a task-processor allocating unit performs operation explained below.
Task information such as a register value stored in a processor that executes the task is saved in the TASK execution information table.
A task ID of the task is registered at the end of the TASK-start-standby queue table.
The next executable task ID is acquired from the top of the TASK-start-standby queue table and deleted from the top of the queue table.
The task information saved in the TASK execution information table is returned to the processor to execute the task.

A method of detecting illegal memory access according to this embodiment is explained in detail below with reference to the software shown in FIG. 3 as an example.

In the case of a multiprocessor, because there are a plurality of tasks that can be simultaneously executed, unlike a single processor, simultaneous access to a shared memory section at the same time could occur. Therefore, certain one processor has to detect not only illegal access to an own task executed by the processor but also illegal access from other tasks executed by the other processors in an occupation period of a shared memory.

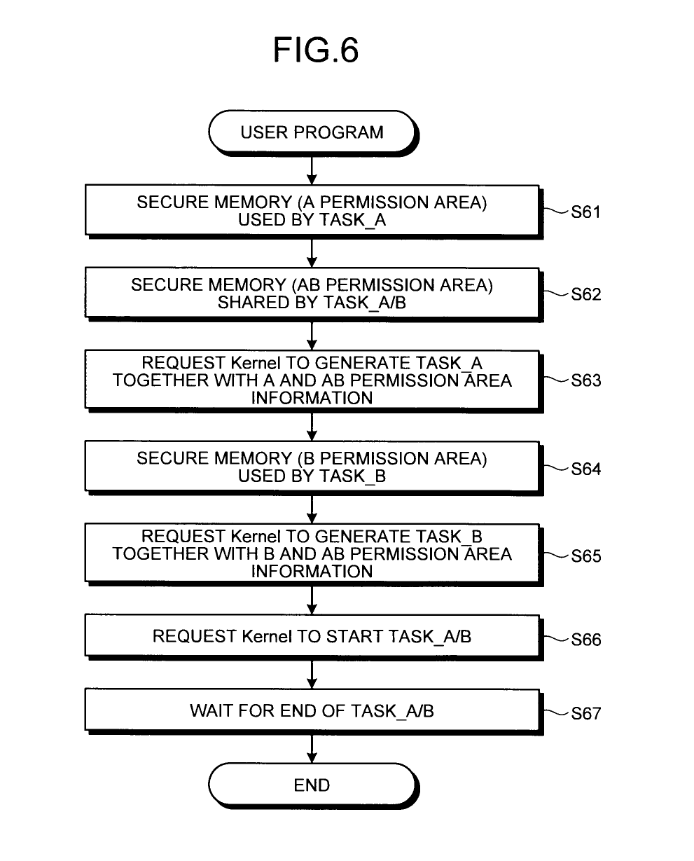

A specific example of a flowchart for explaining the operation of the user program 30 shown in FIG. 3 is shown in FIG. 6.

First, the user program 30 is executed in the application to generate two tasks, TASK_A and TASK_B. The user program 30 secures a memory (an A permission area) used by TASK_A (S61). The user program 30 secures a memory (an AB permission area) shared by TASK_A and TASK_B (S62). The user program 30 requests the kernel 40 to generate TASK_A together with information concerning the A permission area and the AB permission area (S63). The user program 30 secures a memory (a B permission area) used by TASK_B (S64). The user program 30 requests the kernel 40 to generate TASK_B together with information concerning the B permission area and the AB permission area.

In other words, at S61 to S65, the user program 30 performs definition of memory areas independently used by TASK_A and TASK_B (S61 and S64) and definition of a memory area shared by TASK_A and TASK_B (S62). The user program 30 notifies the kernel 40 of the definitions as generation information concerning TASK_A and TASK_B.

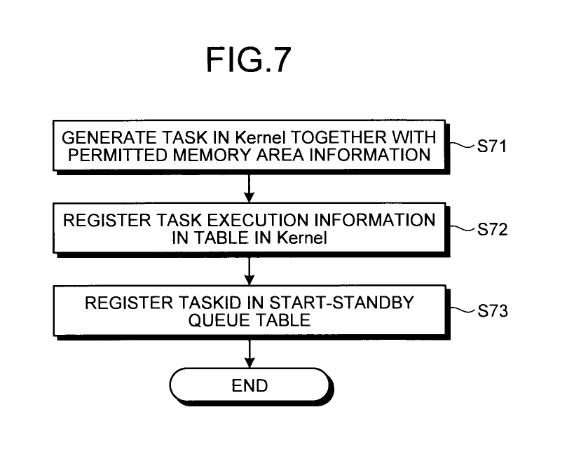

A flowchart for explaining the operation of the kernel 40 during generation and during start of a task is shown in FIG. 7.

During generation of a task in the user program 30, the kernel 40 generates the task in the kernel together with permitted memory area information (S71) and registers task execution information in the TASK execution information table (S72). The kernel 40 puts the TASK execution information table and the TASK-start-standby queue table under the management of the kernel 40.

Thereafter, the user program 30 requests the kernel 40 to start TASK_A and TASK_B (S66 in FIG. 6) and starts the tasks of the software. The kernel 40 registers the TASKID in the TASK-start-standby queue table (S73 in FIG. 7). Thereafter, the user program 30 waits for the end of TASK_A and TASK_B (S67).

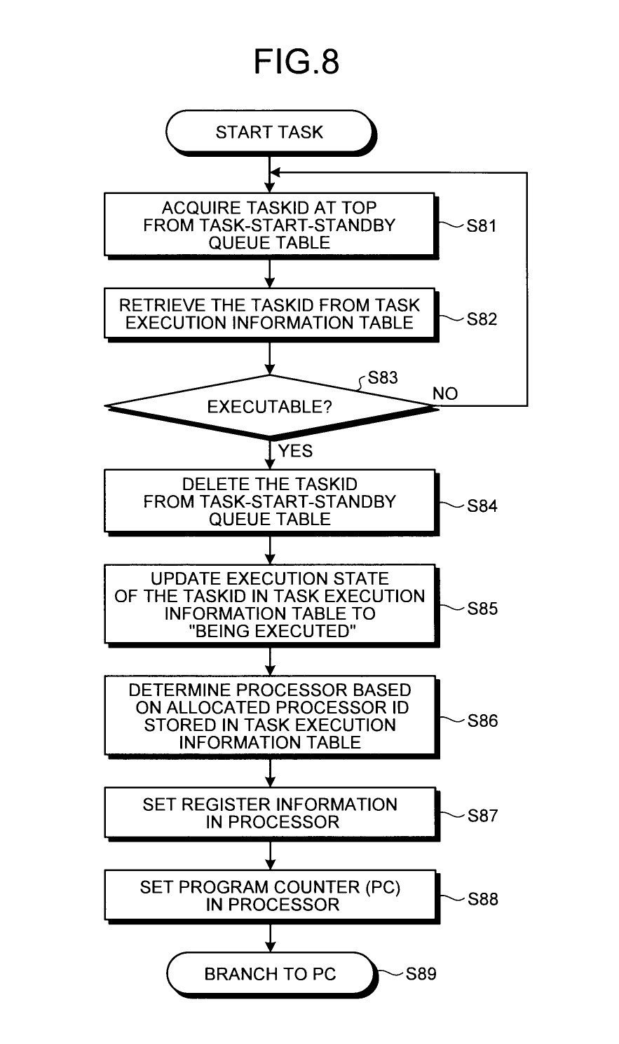

A more detailed flowchart of the operation in the kernel during task start is shown in FIG. 8.

As shown in FIG. 8, when a task is started, first, from the top of the TASK-start-standby queue table, the kernel 40 determines a task ID to which a processor is allocated (S81). The kernel 40 retrieves the task ID from the TASK execution information table (S82). The kernel 40 determines whether a free processor, which is not executing a task, is present. When a free processor is present, the kernel 40 proceeds to S84. When a free process is not present, the kernel 40 returns to S81.

At S84, the kernel 40 deletes the task ID at the top of the TASK-start-standby queue table. The kernel 40 updates an execution state (a TASK state) of the task ID in the TASK execution information table to “being executed” (S85). The kernel 40 determines, based on the allocated task ID stored in the TASK execution information table, a processor that executes the task (S86). The kernel 40 allocates register information also stored in the TASK execution information table to the processor (S87).

Subsequently, the kernel 40 sets a program counter (PC) in the processor (S88). The PC is an address of a memory that should be executed next. However, when a task is suspended, the PC is an address somewhere in the task. Finally, the processor determined at S86 branches to the PC to perform actual task execution (resumption) (S89).

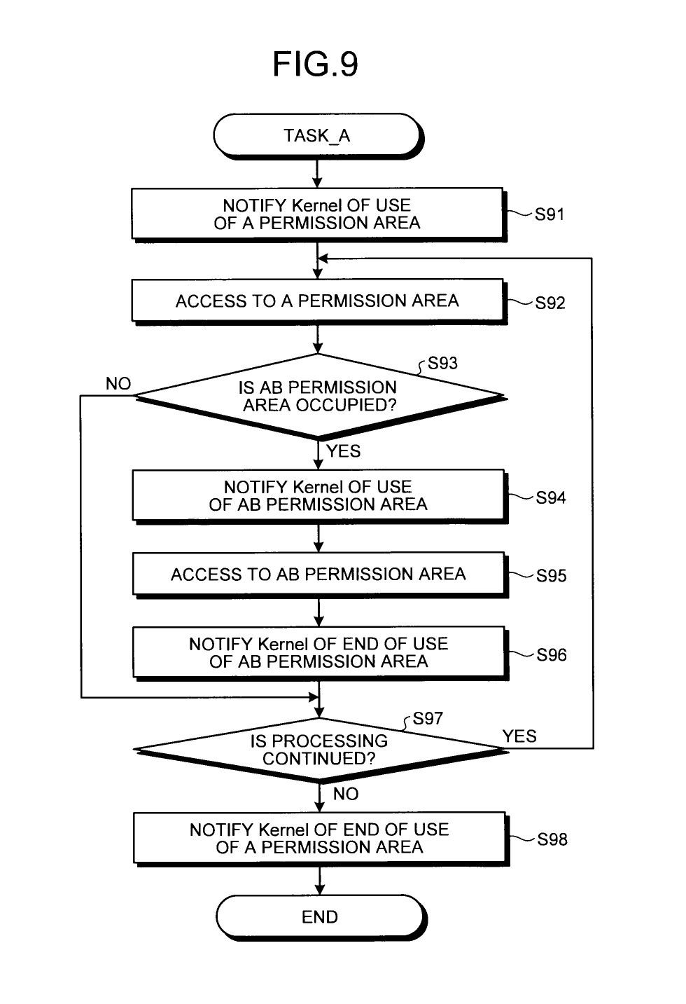

FIG. 9 is a specific processing content example of TASK_A.

First, TASK_A notifies the kernel 40 of use of the A permission area (S91) and accesses the A permission area (S92).

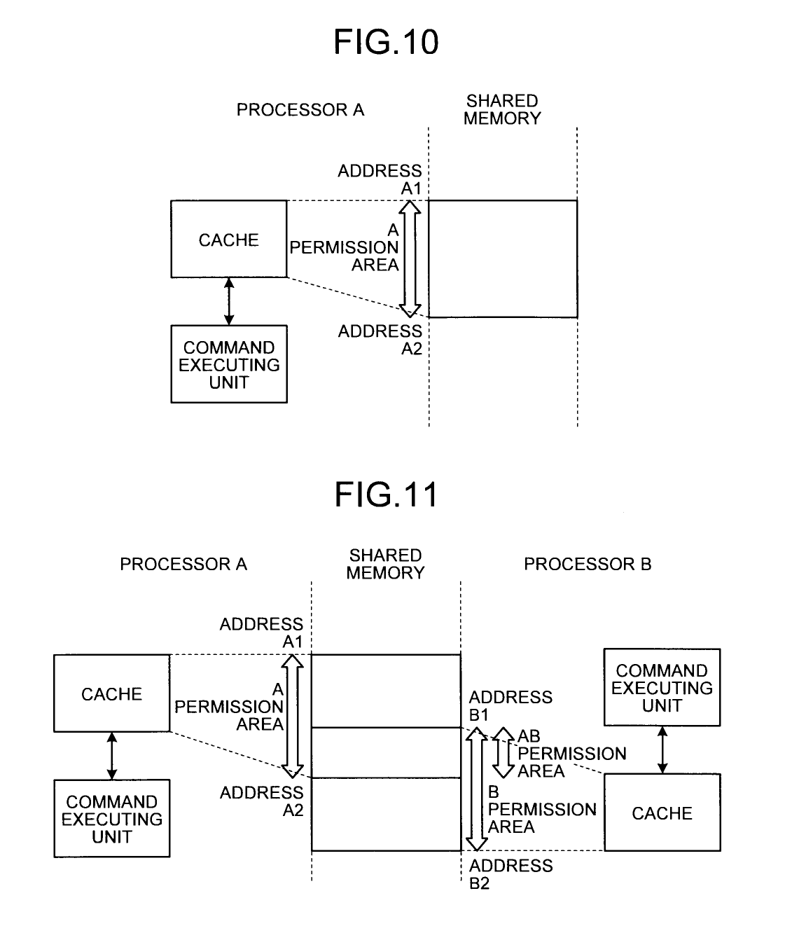

An access area accessed by TASK_A when only TASK_A operates is shown in FIG. 10.

Illegal memory access of TASK_A can be detected by setting, before access to the A permission area shown in FIG. 10, address information in a range excluding the A permission area indicated by addresses A1 to A2 in FIG. 10 (same as the A permission area stored in a memory area entry in the TASK execution information table shown in FIG. 4) in the memory-access-break generator 4 shown in FIG. 1 as an internal area definition.

It is assumed that a shared memory area (the AB permission area) of TASK_A and TASK_B is present and TASK_A desires to suppress access to the AB permission area by TASK_B and occupy the AB permission area. A shared memory including an access area (the AB permission area) that both TASK_A and TASK_B intend to access is shown in FIG. 11.

Before invocation of access permission to the AB permission area, TASK_A performs occupation check for the AB permission area (S93).

When information concerning whether the AB permission area can be currently occupied is stored in a predetermined storage area and it is confirmed that the AB permission area can be occupied (YES at S93), TASK_A notifies the kernel 40 of use of the AB permission area (S94). TASK_A accesses the AB permission area (S95). After the processing ends, TASK_A notifies the kernel 40 of the end of the use of the AB permission area (S96). When the AB permission area cannot be occupied (NO at S93), TASK_A proceeds to S97. When the processing for accessing the A permission area is continued (YES at S97), TASK_A returns to S92. When the processing for accessing the A permission area ends (NO at S97), TASK_A notifies the kernel 40 of the end of the use of the A permission area (S98).

Specifically, information concerning whether the AB permission area is occupied by TASK_A or TASK_B is stored in the predetermined storage area. In the case of TASK_A, TASK_A can occupy the AB permission area when TASK_B does not occupy the AB permission area. On the other hand, in the case of TASK_B, TASK_B can occupy the AB permission area when TASK_A does not occupy the AB permission area.

A correct computer program concerning exclusive use of the shared memory area by TASK_A and TASK_B requires that occupation permission check for a shared memory among tasks is performed in all the tasks.

Therefore, two cases explained below are assumed as causes of an illegal access error concerning the shared memory 14 committed by a user.

(Assumption 1): TASK_A (the own task) performs the occupation check (S93) but TASK_B (the other task) does not perform the occupation check. In other words, the task of the other processor performs memory access neglecting a task that occupies the AB permission area.
(Assumption 2): TASK_A (the own task) does not perform the occupation check (S93). In other words, the own task accesses the AB permission area neglecting occupation of the AB permission area by the task of the other processor.

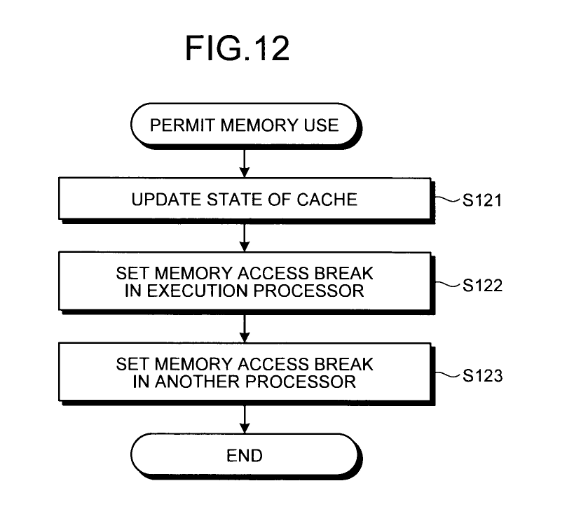

A flowchart for explaining the operation of the kernel 40 during memory use permission notification in this embodiment for solving this problem is shown in FIG. 12. First, when memory use permission is notified to the kernel 40, the kernel 40 updates a state of a cache (S121) and sets memory access break (an internal area definition) in the execution processor (S122).

The kernel 40 sets memory access break in the other processor (S123). Specifically, the kernel 40 sets, as an external area definition, the AB permission area of the memory area entry shown in the TASK execution information table. Consequently, the execution processor has an area definition of the other processor as information. Therefore, the execution processor can detect illegal access to the shared memory 14 by performing occupation check.

In this embodiment, the AB permission area of the shared memory 14 is stored in the detection-area defining unit 41 of each of the microprocessors. Therefore, the access detecting unit 42 that monitors memory access information can detect the illegal access as in the (assumption 1) and (assumption 2) by generating a break signal to the command executing unit 1.

As explained above, in this embodiment, an application program interface (API) is determined on a computer program to prevent conflict from occurring concerning mutual use in access to a memory area commonly used between processors. The user can invoke the API in the computer program before performing memory operation and use coherency of a cache without failure.

In this embodiment, the symmetric shared memory multiprocessor system is explained as an example. However, in the present invention, a multiprocessor system is not limited to a symmetric multiprocessor system as long as the multiprocessor system includes a shared memory.

The number of processors can be equal to or larger than two. Specifically, if one processor informs, as an external area definition, the other processor, which has a memory access break function, of a shared memory area to which tasks executed on the two processors among a plurality of processors access in common, the processor can detect illegal access of the other processor. Therefore, because the two processors have a function of informing memory-access-break generators thereof of the shared memory area as external area definitions each other, the processors can detect illegal access each other.

In the embodiment, in the multitask program executed by the multiprocessor, means for detecting illegal memory access among a plurality of tasks allocated to respective processors by a multiprocessor kernel is provided.

As a method for the means, at a point when tasks of user programs executed in the processors issue a memory access protocol API for keeping consistency of caches of the processors, i.e., at a point when the tasks invoke a kernel API, the multiprocessor kernel recognizes that memory use by the tasks is declared.

At that point, a memory access break function for detecting illegal memory access provided in a processor is set for the outside of a memory area used by a task. At the same time, for a shared memory area shared by the task with the other tasks, a shared memory area among tasks being executed is set as memory access break of other processors.

Attention is paid to a certain task being executed in a certain processor. When the task accesses the outside of an area that the own task is permitted to use, memory access break occurs in a processor that is executing the task. Besides the access to the outside of the permitted area, when the shared memory area among the tasks being executed is accessed by another task being executed by another processor, memory access break occurs in a processor that is executing the other task.

Therefore, it is possible to detect, as memory access break that occurs in the respective processors, illegal memory access that occurs when a plurality of tasks are executed among multiprocessors.

With the multiprocessor system and the method of detecting illegal access according to this embodiment, it is possible to detect illegal access concerning use of a shared memory among tasks at low cost in a multiprocessor system not having a cache coherency mechanism and a memory protection mechanism for a cache system.

Therefore, it is possible to define kernel software for a multitask multiprocessor running on the multiprocessor system that is a memory area used by a user program task. It is possible to realize kernel software that detects, from invocation of a cache state operation API equipped in a kernel from the user program task, i.e., kernel API invocation by user program tasks, conflict concerning use of a shared memory among tasks, i.e., likelihood of illegal memory access.

In a microprocessor that causes memory access break when a break occurrence memory area is accessed, when a processor on which the kernel is running can determine a shared memory area statically, i.e., before a task is executed, the area is defined as an illegal memory access area and designated as a break occurrence memory area. This makes it possible to detect illegal access by the user program task to a memory area used by the kernel.

With a microprocessor that can designate the break occurrence memory area from the outside of the processor, it is possible to provide means for detecting illegal memory access even to a processor on which the kernel is not running. In other words, the operation in this embodiment can also be performed by a user program without using a kernel API and without interposing the kernel.

With kernel software that sets, in invocation of the cache state operation API equipped in the kernel, a break occurrence memory area on the outside of a memory area used by the user program task in a processor that invokes the cash state operation API, it is possible to provide means for detecting illegal access to the outside of a usable area of the user program task for which an access prohibited memory area is dynamically switched.

Further, in invocation of the cache state operation API equipped in the kernel, the kernel software sets, as a break occurrence memory area of other microprocessors excluding a microprocessor that is executing the user program task that invokes the cache state operation API, a memory area shared by a user program task that invokes the cache state operation API and other user program tasks. Therefore, it is possible to detect illegal memory access by the other tasks in a hardware manner.

As explained above, according to the embodiment of the present invention, it is possible to improve debug efficiency in the shared memory multiprocessor system and at the same time reduce cost.

According to an aspect of the present invention, there is an effect that it is possible to detect illegal memory access of software in a processor in a multiprocessor system having a shared memory.

According to another aspect of the present invention, there is an effect that it is possible to detect illegal memory access of software in a multiprocessor system having a shared memory.

According to a still another aspect of the present invention, there is an effect that it is possible to detect illegal memory access of software in a method of detecting illegal memory access in a multiprocessor system having a shared memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A processor included in a multiprocessor system including a shared memory, the processor comprising:
a storing unit that stores a break occurrence memory area that is address information of the shared memory; and
a break generator that causes memory access break when the break occurrence memory area is accessed and puts the processor to a debug state, wherein
the break occurrence memory area includes address information of the shared memory in another processor included in the multiprocessor system.

2. The processor according to claim 1, wherein the break occurrence memory area is address information indicating an area of the shared memory that both of a first task running on the processor and a second task running of the other processor are permitted to use.

3. The processor according to claim 2, wherein the processor performs, based on occupation information concerning whether the area of the shared memory that both the first and second tasks are permitted to use is occupied by the second task, memory access to the break occurrence memory area only when the area is not occupied.

4. The processor according to claim 1, wherein the break occurrence memory area includes address information of an area of the shared memory that a first task running on the processor is not permitted to use.

5. The processor according to claim 4, wherein the address information indicating the area of the shared memory that the first task is not permitted to use is the break occurrence memory area.

6. A multiprocessor system comprising:
a shared memory;
a first processor that accesses the shared memory; and
a second processor that accesses the shared memory, wherein
the first processor includes:
a first storing unit that stores a first break occurrence memory area that is address information of the shared memory; and
a first break generator that causes memory access break when the first break occurrence memory area is accessed and puts the first processor to a debug state,
the second processor includes:
a second storing unit that stores a second break occurrence memory area that is address information of the shared memory; and
a second break generator that causes memory access break when the second break occurrence memory area is accessed and puts the second processor to a debug state, and
the first break occurrence memory area includes address information of the shared memory in the second processor and the second break occurrence memory area includes address information of the shared memory in the first processor.

7. The multiprocessor system according to claim 6, wherein the address information designated as the first break occurrence memory area and the address information designated as the second break occurrence memory area are the same.

8. The multiprocessor system according to claim 7, wherein the designated address information indicates an area of the shared memory that both of a first task running on the first processor and a second task running on the second processor are permitted to use.

9. The multiprocessor system according to claim 8, further comprising a unit that stores occupation information concerning whether the area of the shared memory that both the first and second tasks are permitted to use is occupied by the first or second task, wherein
the first processor is permitted to perform memory access when the area is not occupied by the second task, and
the second processor is permitted to perform memory access when the area is not occupied by the first task.

10. The multiprocessor system according to claim 6, wherein
the first break occurrence memory area includes address information indicating an area of the shared memory that a first task running on the first processor is not permitted to use, and
the second break occurrence memory area includes address information indicating an area of the shared memory that a second task running on the second processor is not permitted to use.

11. A method of detecting illegal access to a shared memory in a multiprocessor system including the shared memory, a first processor, and a second processor, the method comprising:
designating, as a first break occurrence area, address information of the shared memory accessed by the second processor;
monitoring access to the shared memory by the first processor; and
putting the first processor to a debug state and causing memory access break when it is monitored that the first processor accesses the designated first break occurrence memory area.

12. The method of detecting illegal memory access according to claim 11, wherein the address information designated by the second processor indicates an area of the shared memory that both of a first task running on the first processor and a second task running on the second processor are permitted to use.

13. The method of detecting illegal memory access according to claim 12, further comprising checking whether the area of the shared memory that both the first and second tasks are permitted to use is occupied by the second task, wherein
the first processor is permitted to perform memory access only when the area is not occupied.

14. The method of detecting illegal memory access according to claim 11, wherein the first break occurrence memory area includes address information indicating an area of the shared memory that a first task running on the first processor is not permitted to use.

15. The method of detecting illegal memory access according to claim 14, further comprising designating, as the first break occurrence memory area, the address information indicating the area of the shared memory that the first task is not permitted to use.

16. The method of detecting illegal memory access according to claim 11, further comprising:
designating, as a second break occurrence memory area, address information of the shared memory accessed by the first processor;
monitoring access to the shared memory by the second processor; and
putting the second processor to a debug state and causing memory access break when it is monitored that the second processor accesses the designated second break occurrence memory area.

17. The method of detecting illegal memory access according to claim 16, wherein the address information designated as the first break occurrence memory area and the address information designated as the second break occurrence memory area are the same.

18. The method of detecting illegal memory access according to claim 17, wherein the designated address information indicates an area of the shared memory that both of a first task running on the first processor and a second task running on the second processor are permitted to use.

19. The method of detecting illegal memory access according to claim 18, further comprising checking whether the area of the shared memory that both the first and second tasks are permitted to use is occupied by the first or second task, wherein
the second processor is permitted to perform memory access when the area is not occupied by the first task, and
the first processor is permitted to perform memory access when the area is not occupied by the second task.

20. The method of detecting illegal memory access according to claim 16, wherein
the first break occurrence memory area includes address information indicating an area of the shared memory that a first task running on the first processor is not permitted to use, and
the second break occurrence memory area includes address information indicating an area of the shared memory that a second task running on the second processor is not permitted to use.
